(19) United States
(12) Patent Application Publication
(10) Pub. No.: US 2021/0310274 A1
(43) Pub. Date: Oct. 7, 2021

(54) Disposable doorknob cover with dispenser

(71) Applicant: Karen Curcio, Meriden, CT (US)

(72) Inventor: Karen Curcio, Meriden, CT (US)

(21) Appl. No.: 16/844,956

(22) Filed: Apr. 9, 2020

Related U.S. Application Data
(60) Provisional application No. 63/004,085, filed on Apr. 2, 2020.

(51) Int. Cl. E05B 1/00; B65D 83/08

(52) U.S. Cl. CPC E05B 1/0061; B65D 83/0894

(57) ABSTRACT

A hollow body disposable knob cover is made of a flexible piece of material with an opening sewn of elastic to form fit over the knob down in the projection stem area of knob, upon releasing the disposable knob cover on knob. This disposable knob cover will provide the reduction of cross contamination from multiple users of such things as a door or faucet with a knob, or any knob which may not be sanitized enough with disinfectants. This disposable knob cover is made with either imposed layer of spunbonded polypropylene or polyethylene in either vacuum formed or molded or threaded form or other material such as plastic foam, film formed of block copolymers of styrene and butadiene or elastomeric films of polyurethane or a paper material or non-porous moisture resistant material. The Art form of existing disposable foot covers for the medical profession will be changed to an Art form of disposable knob covers for use by consumers, hospitals, businesses, and in public places. In addition, a dispenser to hold and dispense disposable knob covers can be utilized for easy access and convenience as well as storing in a box ejecting one at a time.

### CROSS REFERENCE TO RELATED APPLICATION

Not Applicable

### FEDERALLY SPONSORED RESEARCH OR DEVELOPMENT

Not Applicable

### REFERENCE TO MICROFICHIE APPENDIX

Not Applicable

### BACKGROUND OF THE INVENTION

In prior 1921 U.S. Pat. No. 1,633,988, there was a considerable effort to develop disposable door knob protectors, for many reasons such as transporting doors for scratching and breaking and preventing harmful chemicals in the paint from seeping out of knob. This prior invention had a hollow body formed of flexible material preferably fabric or felt shaped to correspond with the shape of knob or handle. It had a “hem” at the end which a rubber band or elastic extends through to “draw tightly” the shank of the knob or handle. This invention was to keep the cover on for long periods of time for protecting items from scratches, not people from germs, as this new disposable knob cover invention. This new invention will not need a “draw tightly” method. The stretchable forming elastic will be sewn at the opening of the hollow body material and form fit down the projection stem area of knob. There will be no HEM in the new improved invention.

In prior Pat. US 2006/0059663 A1, this simple disposable-sanitary door knob/handle shield or glove with a dispenser and wastebasket to dispose was a cumbersome shaped like a coffee filter that corresponds to the shape of the door knob or handle. This glove or cover shield was provided to prevent cross contamination of germs between multiple users of the same door knob, but only “compliments” the shape of the door knob. This new invention will have a hollow body made of a disposable light weight material for the disposable knob cover following the actual shape of the knob, and environmentally limiting waste material.

In U.S. Pat. No. 4,856,140, issued to Visco et al., discloses a sanitary handle cover for either a door knob or toilet handle. It is a cup-like gadget but its degree of effectiveness in combating germs is limited with multiple uses of the same knob. The slits in the design for gripping do not at all assist with germ protection. This new invention has a soft hollow body with material that follows the shape of the knob for a fit with a stretchable sewn elastic at the opening for form fitting down to projection stem area of the knob.

In U.S. Pat. No. 4,921,028 issued to Schwartz, is a cover for door hardware which has a plastic sheet attached to the base of the door hardware and to cover the door when painting with adhesive strips attached to the paint covering to the door handle. This is very different from this new invention because the prior invention has adhesive strips for covering and protecting items while paining and then removing.

In U.S. Pat. No. 5,840,122 A, issued to Williams, is another door knob cover for enclosing a door knob during painting with a spherical knob cover. This invention was assorted sizes and shapes of decorative door covers with a face on them and a string hanging down. This new invention has a flexible hollow piece of disposable material, stretchable sewn elastic at the opening to go over the knob and down the projection stem of the knob for preventing cross contamination of germs, not protecting fixtures from paint as seen here in the old invention.

In U.S. Pat. No. 5,713,615 A, issued to Tsai, a stretchable door knob cover of soft cloth material with a spherical top, narrow neck and wider base. The opening of the base- and flexibility allow a stretch and fit over the door knob. There is a cumbersome string laced through neck of door knob cover and tied tightly to secure cover on knob. This is decorative and of cloth construction with little degree of sanitary protection. This new invention will involve a quick attachment and release (removal) ability of the light weight hollow body material with just a few fingers by using a sanitary protection type of material when producing disposable knob cover.

In U.S. Pat. No. 5,008,551, issued to Randolph, the door knob is molded from a mixture of a powder with two halves and a hinge to secure it. “A luminescent door knob cover. The cover is molded from an admixture of a phosphorescent powder and a carrier. A first half of the cover overlies a first half of a door knob and the first half of a door knob neck when the device is operatively installed. A second half of the cover overlies a second half of the door knob and the second half of the door knob neck when the device is operatively installed. A hinge is formed in the cover to facilitate placing it on and removing it from door knobs. An annular band secures the cover to the door knob.” U.S. Pat. No. 5,008,551. This is very different from the new invention in that there are not two halves or a hinge to secure it. The new invention is a hollow body piece of disposable material formed around the knob with an opening sewn of elastic form fitting down the projection stem area of the knob.

In U.S. Pat. No. 3,343,578, issued to Rubin, the door knob handles were made to be pleasing to the eye more for a decorative look to the door.

Finally, U.S. Pat. No. 6,546,594 B1 to Willis, discloses a door handle covering with a shaft elasticized or plasticized material in the body with a three-dimensional shape with an inner face, an outer face and an opening with a narrow neck. This is an elasticized covering, but this requires carrying the handle for quick portability and quick affixation. This was an improvement, but not the solution. The portably carry coverings for quick affixation and removal from door handles is not preventing germs from spreading in the best manner. This invention's covering devices can be packaged in different sizes to accommodate different types of door knobs which is different than the new invention. The prior invention does not solve the germ protection problem. A more disposable material and design such as this new invention will solve this problem better. A standard knob size such as a door knob or a limited number of sizes will be an improvement in the new invention by providing a simple hollow piece of material for quick attachment and release from the knob and disposal of the knob cover. Unlike the old invention which requires carrying a handle for quick portability and quick affixation, this new invention's purpose is to quickly protect and discarded in the trash with minimal effort.

People need to maintain sanitary and sterile conditions of various publicly available facilities, in hospitals, businesses, and at home for consumers. Germs on surfaces such as door knobs, and faucet knobs are becoming more and more susceptible to spreading from one user to another. Opening a door knob or turning on/off up/down a faucet knob constantly is a major feeding ground for germs with multiple individuals participating in the task often and the spraying of disinfectants can be intermittent and not done enough times (before each entry) to prevent the potential for spreading germs in public places as well as home environment.

The above prior devices attempt to provide some sort of protections, some with germ protection in mind, as the new invention has at its forefront. The prior inventions all have a form of means to cover or create a shield on a door knob for a protection of some sort. That is, the handling with fingers and hands not coming in direct contact with the germs and bacteria that may reside on exposed surfaces of such door knobs and handles. These previous covers are not society friendly, for mass production, with a purpose of pandemic virus protection or other contamination protection for quick disposability, quick attachment to a door knob and quick release from a door knob for example while being able to discard in the trash with minimal effort. The prior inventions are expensive, not easy to use and do not prevent cross contamination efficiently for mass production as does the new invention will be able to do while serving many different types of facilities and users with mass production for every consumer to find a use for. The new invention disposable knob covers consisting of a hollow body can even be put on a round sink faucet for a quick turn on and off for disposable protection without much effort or requiring a completely forming fit. The disposable knob cover with its hollow body can be used as yet another form of a disposable barrier from a contaminated surface using one's hands and or fingers as easily as grabbing a paper towel.

In addition, some of the prior inventions were not specifically geared toward mass production of a disposable knob cover for a pandemic for virus protection. With the new invention, society will have a light weight hollow body of material that is an environmentally safe disposable knob cover, with little waste accumulation in disposability in daily use for sanitation purposes. Unlike Kellaher and Balzano's prior inventions with sanitary agents inside the knob needing to release agent in order to sanitize hands or fingers, this one time use disposable knob cover uses an improved non-latex, non-porous material, with little waste, little risk of allergic reaction upon touching disposable knob cover.

What is needed is a device such as the new invention which is a devise to cover germ exposed surfaces of a knob, which is inexpensive, can be used with most standard knobs, protects a user from being in contact with such unsanitary or unsterile surfaces, produced in mass production, inexpensive to produce, can be stored in a dispenser to store and dispense the disposable knob covers, so that further contamination is eliminated in high traffic areas or the disposable knob covers can be supplied in a cardboard box in various quantities.

DELETED

### BRIEF SUMMARY OF THE INVENTION

The present invention relates to a disposable knob cover. A protector for knobs (a rounded lump or ball at the end or on surface of something) which is usually made of such things as metal, glass, plastic, or wood mostly found on a door. It relates' to hygienic covers to protect from unsanitary and unsterile conditions. The disposable knob cover is a hollow body flexible piece of disposable material with an opening to pass through the knob with elastic sewn around opening for a form fit down the projection stem area of the knob. A disposable knob cover will fit most interior or exterior knob dimensions and imposes a layer of either spunbonded polypropylene or polyethylene in either vacuum formed or molded or threaded form, with sewn not glued Elastic opening to down over the projection stem area of knob, that is non-conductive, latex free. Other material used may include plastic foam, or film formed of block copolymers of styrene and butadiene or elastomeric films of polyurethane or a paper material or a non-porous moisture resistant material. There is a sewn opening with elastic for durability to prevent tearing and a secure fit as the material is handled when grabbing a knob to open a door or turn on/off faucet knob with a firm grip of a hand or fingers. This disposable knob cover is simple, inexpensive, easy to use for protecting one's hands from cross contamination of germs. The quick attachment of the disposable knob cover and quick release is a new improvement along with discarding in the trash with one time use only with minimal effort. The new invention will be using material similar to what is currently being used for disposable footwear shoe covers by medical professionals and changing the art form to a disposable knob cover.

Accordingly, it is an object of invention to provide a disposable knob cover for protecting one's hands from coming in contact with surfaces that contains germs on exposed surface of a knob with a quick attachment and release to knob discarding in trash with minimal effort.

Another object of the disposable knob cover is the hollow flexible piece of disposable material with an opening to pass through the knob with a sewn elastic at opening will form fit over projection stem area of knob.

Another object of the invention is to provide a material molded/threaded or vacuum forming polyethylene or spunbonded polypropylene and or use as a fiber material in a durable manner with no liquid fluid issues to be concerned with as with the surgical booties that use a similar material concerned about coming in contact with liquids.

In yet another object, the disposable knob cover can be quickly attached to the knob and removed with a quick release with only a few fingers with each use and disposed of in an everyday waste basket with minimal effort.

Another object is the invention is to prevent cross contamination of germs such as the spreading of contaminating germs.

Another object is the disposable knob cover can be stored and stacked in a dispenser container within reaching distance or in close proximity to an interior or exterior door with high public traffic for germ prevention to a door knob.

DELETED

Another object is the disposable knob covers will be stacked in a cardboard box in various quantities for economically feasible cost to consumers as seen in existing invention of disposable plastic gloves.

Another object being sought by the invention is a disposable knob cover for protecting one's hands from germs in a simple, inexpensive manner, being easy to make, easy to use with the material already being widely utilized and easily accessible in the industry in such things as disposable surgical foot coverings. (i.e., spunbonded polypropylene material)

Another object being sought by the invention of disposable knob covers is the knob cover is a hollow body of material soft to touch, thin, non-porous, light weight, yet is form fitting to the knob easily when formed around the knob and projection stem area of the knob, such as a door knob.

Another object of the invention of disposable knob covers is that the material being used allows for no bulk waste as seen in other cup like plastic door knob covers, with the new invention comes a more environmentally friendly purpose than previous inventions of door knob covers.

Another object of the invention of the disposable knob cover is the material such as plastic foam or paper material or a non-porous high elongation thermoplastic elastomeric film may be used or moisture resistant material.

Another object of the invention for the disposable knob cover is sewn elastic around the opening of the material with the opening being large enough or stretchable enough to pass the knob, with elastic opening to form fit down to the projection stem area of the knob.

Another object of the invention for the disposable knob cover is using material such as utilizing an elastomeric polyurethane film material.

Another object of the invention for the disposable knob cover is using material such as butadiene-styrene copolymer may be used.

Another object of the invention for the disposable knob cover is another form of a disposable barrier from a contaminated surface using one's hands and finger.

Another object of the invention for the disposable knob covers is they will be most useful in pandemic virus crisis situations to contain the spread of viruses.

Another object of the invention for the disposable knob covers is improvements from spraying of disinfectants or some prior art of filling knobs with a sanitary agent that releases upon grabbing the knob when those both can be intermittent and not done enough times with multiple uses of a knob in heavy traffic areas, such as on a door knob.

### BRIEF DESCRIPTION OF THE DRAWINGS

Reference will now be made to the attached drawings, with the following detailed description, where the reference numerals are referred to in each:

FIG. 1A. Is a side view of a disposable knob cover for use in connection with a knob such as a door knob insertably received over the knob of the door. It shows the sewn elastic opening for form fitting over the projection stem area of the knob.

FIG. 2A. It is a view of disposable knob cover, with a hollow body of material to form fit down to the projection stem area to the knob with an elastic opening.

FIG. 3A. This is a view of a hand gripping a door knob which has a disposable knob cover protecting hands while turning handle potentially otherwise would have been contaminated with germs.

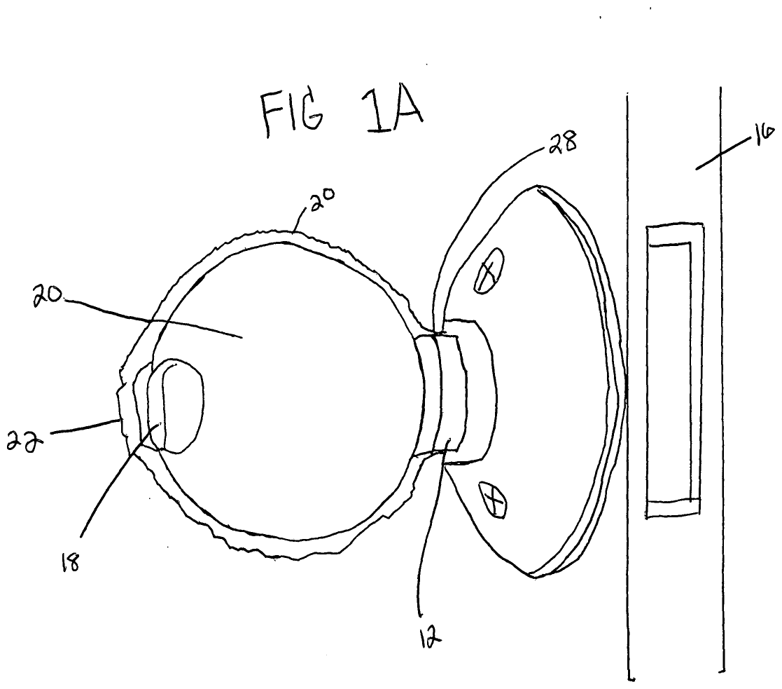

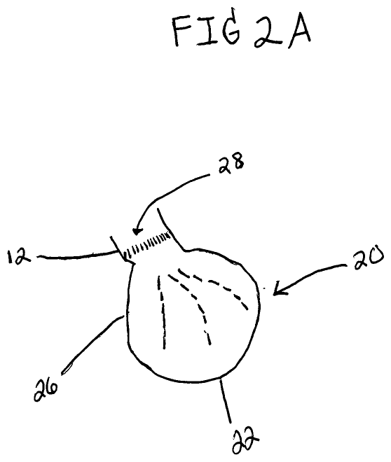

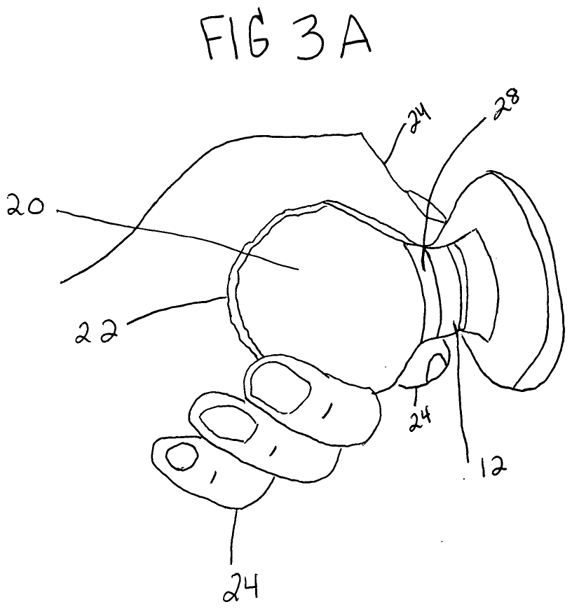

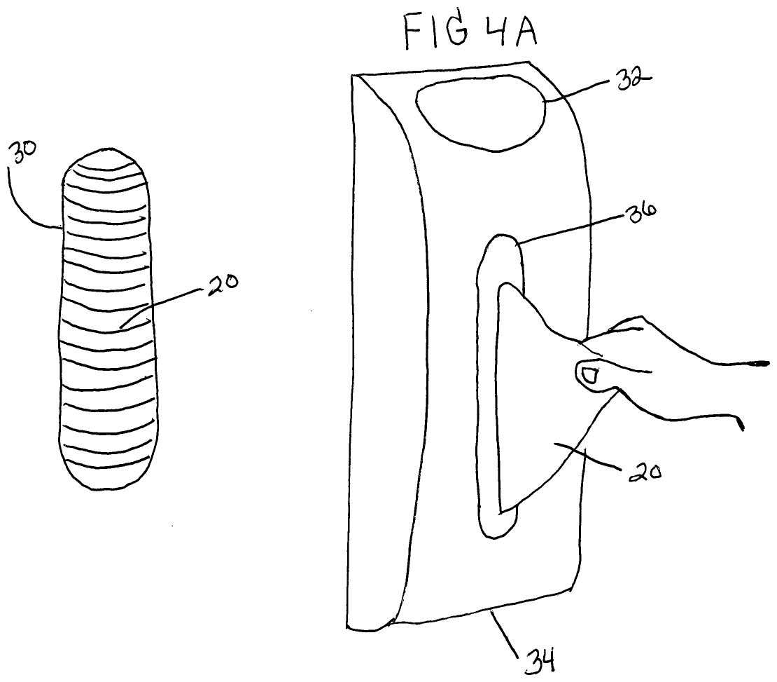

DELETE

### DETAILED DESCRIPTION OF THE PREFERRED EMBODIMENT

A disposable knob cover will now be detailed to accompany the drawings outlined above.

As illustrated in the figures above, the following is a description of a disposable knob cover 20 for use on a knob 18, attached to a knob 18 (illustrated on a door knob) of a door 16. The disposable knob cover 20 is hollow, flexible piece of material with a closed bottom 22 with an open end 28 to pass through the knob 18 with elastic type material sewn around opening 28 to attach to the projection stem 12 area of knob 18. The disposable knob cover 20 resembles the material (similar to material used in existing surgical booties in hospitals) formed in a hollow body shaped disposable knob cover 20 to correspond with the shape of the knob 18, it will be associated with. The diameter of the bottom 22 is larger tapering in the shape of a knob wall 26 smaller to the diameter at the open end 28 of the disposable knob cover 20. The diameter of the bottom surface 22 corresponds approximately to the diameter of the knob 18. The size of the disposable knob cover 20 is approximately the size that when applied over the knob 18, it will cover the knob 18 form fitting, and a portion of the knob 18, projection stem area 12, offering a complete barrier between the skin of a hand 24 and fingers 24 of a hand 24 with the surface of the knob 18, preventing germs to come in contact with exposed surface of knob 18.

### DETAILED DESCRIPTION OF PRESENT INVENTION

The present invention relates to disposable knob covers. A protector for knobs (a rounded lump or ball at the end or on surface of something) which is usually made of such things as metal, glass, plastic or wood. It relates to hygienic covers to protect from unsanitary and unsterile conditions. The disposable knob cover is a hollow body flexible piece of material with an opening to pass through the knob with an elastic sewn around opening for form fitting over the projection stem area of the knob. This invention is for a disposable protectable knob which can be stored in a dispenser to dispense and hold the same to mount on a wall outside of high traffic areas such as busy hospitals, grocery store bathrooms, or interior doors in and around bathrooms, in homes, at businesses, doctor's offices, and or the disposable knob covers can be boxed in different varying amounts (25, 50, 100). These disposable knob covers can be widely used by consumers with readily using at home to prevent the spread of germs, such as the flu or to prevent the spread in a virus pandemic.

A disposable knob cover will fit most interior or exterior door knob dimensions and imposes layers of either spunbonded polypropylene or polyethylene in either vacuum formed or molded or threaded, with sewn not glued Elastic opening for form fit down in projection area stem of knob, that is non-conducive, latex free. A sewn opening with elastic to prevent tearing and a secure fit down in projection stem area of knob as the material is handled with grabbing the knob such as a door knob to open. The material can also be a non-porous high elongation thermoplastic elastomer film or even a paper material. It may be a plastic foam since only limited protection from liquids is required for most knobs as opposed to surgical-booties. While various plastic materials may be used, films formed of block copolymers of styrene and butadiene and elastomeric films of polyurethane may also be used. This-disposable knob cover is a simple, inexpensive, easy to use for protecting one's hands from cross contamination of germs. Some of the materials' are already in use with disposable surgical footwear shoe coverings for the medical profession. (i.e., spunbonded polypropylene material).

This invention is changing the art of the material used in disposable footwear shoe coverings for surgical disposable footwear and creating a new art in a disposable knob cover for a larger usage span (i.e., other than hospitals) including consumers fighting germs to prevent the spread of viruses. This would be an improvement from prior knob covers because at the present time germs are more prevalent in the world with international travel and it will increase the ways to protect the nation starting with each individual.

The disposable knob cover would cover the knob and offer a barrier between the skin of the fingers or of the hand to the surface of the knob, so no unsterile matter would come in contact with the exposed surface of the hand.

In addition, a dispenser/container could be used to stack the disposable knob covers for easy pulling one through a hole of a container to then form fit down the projection stem area of the knob upon attaching to a knob such as a dour knob.

The idea is that the cheap light weight disposable knob cover would be placed on the knob before one turn's the knob to open or moves knob on/off or up/down. One removes the disposable knob cover as one goes into the room with a door knob or turns a knob on/off/up/down and throws the disposable knob cover away. The same protection would be afforded from the inside of a door with a door knob coming back out of a room/bathroom and then discard disposable knob cover in trash. Today, many individuals use a paper towel after washing hands to open the door for preventing germs to come in contact with hands after washed hands to avoid germs with pubic door knobs.

The present invention is further an additional improvement over the prior art (see all above) in that it permits a real disposable, cheaply made, sanitizing way to prevent germs from spreading on multiple uses of a knob with material already in the industry being used for protection on surgical booty covers. The close proximity of a dispenser to where the knobs are located as seen with previous inventions of hand sanitizer dispensers and or to provide the disposable knob covers in a cardboard box of such varying amounts of as little as 25, 50, 100 count stacked in a box as seen with prior inventions of plastic gloves, will allow for easy domestic affordability and convenience.

### Example I

A disposable knob cover may be made utilizing for the body of the knob a layer of film of 4 mil (0.004 inches) in thickness of a butadiene-styrene copolymer marketed under the Trademark “Kraton 2109” by Shell Chemical Company, New York, N.Y. with an approximate standard to a door knob dimensions of approximately 1¼ to 1¾ inches to within stem of projection of 1½ to 1¾ inches or bigger for larger door knobs.

### Example II

A disposable knob cover may be made utilizing for the body of the knob a layer formed of spun-bonded polyethylene marketed under the designation “Tyvek” by E. I. du Pont de Nemours, Wilmington, Del., with an approximate door knob dimensions of approximately 1¼ to 1¾ inches to within stem of projection of 1½ to 1¾ inches or bigger for larger door knobs.

### Example III

A disposable knob cover may be made utilizing for the body of the knob a layer formed utilizing an elastomeric polyurethane film material marketed under the designation “Tuftane” by B.F. Goodrich Chemical Company, Cleveland, Ohio.

### Example IV

A disposable knob cover may be made utilizing for the body of the knob a layer formed utilizing an elastomeric polypropylene film material marketed under the designation of Phillips Petroleum Chemists J. Paul Hogan and Robert Banks in 1951 and then, Giulio Natta and Karl Rehn polymerized to a crystalline polymer in 1954. Polypropylene also known a polypropene is a thermoplastic polymer widely produced commodity plastic today.

While in the foregoing I have disclosed preferred embodiments of the invention in considerable detail for illustration purposes, it will be understood by those skilled in the art that many of these details may be varied without departing from the spirit and scope of the invention.

### REFERENCES CITED

### U.S. Pat. Nos

| | | |
|---|---|---|
| 1,633,988 | Jun. 28, 1927 | George Jones |
| 2006/0059663 A1 | Mar. 23, 2006 | Angelo J. D'Ambrosio |
| 4,856,140 | Aug. 15, 1989 | Frank Visco |
| 4,921,028 | May 1, 1990 | Nathan Schwartz |
| 5,840,122 A | Nov. 24, 1998 | Dennis C. Williams |
| 5,713,615 A | Feb. 3, 1998 | Hsu-Hei Tsai |
| 5,008,551 | Apr. 16, 1991 | Timothy T. Randolph |
| 3,343,578 | Sep. 26, 1967 | Morris M. Rubin |
| 6,546,594 B1 | Apr. 15, 2003 | Steven Wills |
| 2006/001062 A1 | Jan. 19, 2006 | Kellaher |
| 8,353,085 B2 | Jan. 15, 2013 | Balzano |

What is claimed new is:

1. A one time use disposable knob cover for an exposed knob usually made of such medal, glass, plastic or wood comprising;
a hollow body flexible piece of material having an opening to pass through the knob with an elastic sewn on opening for a form fit down to the projection stem area of knob.

2. A disposable knob cover means for positioning over a spherical knob area of the knob within which a spherical knob portion of the knob forming over the dimension and projection such as on a door knob.

3. (canceled)

4. (canceled)

5. (canceled)

6. (canceled)

7. The disposable knob covers in claim 1 having only one open end large enough to pass through the knob with a sewn elastic around the opening while receiving said knob through said opening end.

8. The disposable knob covers in claim 1 are a hollow body of material, soft, thin, light weight, inexpensive, easy to use, easy to make, environmentally friendly, with no bulk waste.

9. The disposable knob covers in claim 1 easily attach to the knob and have quick release with only a few fingers used with each use and disposed of in an everyday waste basket with minimal effort.

10. The disposable knob covers in claim 1 are to protect from unsanitary and unsterile conditions found in cross contamination of germs.

11. The disposable knob covers in claim 1 are another form of a disposable barrier from a contaminated surface using hands and fingers.

12. The disposable knob covers in claim 1 covering the knob defining an area approximately the standard size of a door knob with a dimension of 1¼ to 1¾ inches to projection of 1½ to 1¾ inches or slightly larger for larger door knobs.

13. The disposable knob cover of claim 1 in which material for disposable knob covers is either a plastic foam, or film formed of block copolymers of styrene and butadiene or elastomeric films of polyurethane or a paper material or a non-porous moisture resistant material or spunbonded polypropylene or polyethylene in either vacuum formed or molded or threaded fiber form or a non-porous and high-elongation thermoplastic elastomer.

14. The disposable knob cover of claim 1 in which hollow body material is made of the general same size or slightly larger to form fit the shape of a knob down in the projection stem areas of the knob.

15. The disposable knob cover of claim 1 in which said hollow material body opening has an opening to pass through the knob with elastic form fitting down in the projection stem area of knob within close proximity to the knob itself for insertion over a knob.

16. A protective disposable knob cover of claim 1 is for use in many areas such as consumer use on interior/exterior door knobs in homes such as bathroom faucet knobs, door knobs, office and hospital interior doors, doctor's offices and glass door knobs, or grocery store bathroom faucet knobs, door knobs and any other knobs that are touched by hands and or fingers containing germs.

17. The disposable knob covers of claim 1 will be used on knobs that may not be able to be continually sanitized for the multitude and frequency of hands touching the knob.

18. The disposable knob covers of claim 1 will be used when spraying of disinfectants can be intermittent and not done enough times with multiple uses of a knob in heavy public traffic or useful in a pandemic virus situation to contain the spread of virus.

19. The disposable knob covers in claim 1 can be stacked in a card board box with ability to extract one at a time for limiting contamination of spreading germs and an economically feasible cost to consumers.
